(19) United States
(12) Patent Application Publication
(10) Pub. No.: US 2007/0113436 A1
(43) Pub. Date: May 24, 2007

(54) Advertising display panel with image updating and improvements for said display panel

(75) Inventor: Rafael Luis Fernandez Conesa, Málaga (ES)

Correspondence Address: WILLIAM COLLARD;COLLARD & ROE, P.C., 1077 NORTHERN BOULEVARD, ROSLYN, NY, 11576, US

(73) Assignee: Codice Exterior Gestión de Soportes, Málaga (ES)

(21) Appl. No.: 11/480,156

(22) Filed: Jun. 30, 2006

(30) Foreign Application Priority Data
Jun. 30, 2005 (ES) 2005 01492
Jul. 29, 2005 (ES) 2005 01883

(51) Int. Cl. G09F 19/00

(52) U.S. Cl. 40/470

(57) ABSTRACT

Advertising panel with image updating and improvements of said panel, the panel comprising a casing with internal lamps the light of which is transmitted to the outside through an opening with a rigid and fixed transparent portion and a mobile transparent portion parallel and opposite to the former portion, one of the portions incorporating a pattern formed of opaque areas and the other portion incorporating a plurality of fragmented images that follow the pattern of opaque areas to show selectively through the spaces between the opaque areas the fragments of one of the images using the motion of the mobile portion, the opaque areas concealing the fragments of the other images. The improvements consist of integrating both portions in an opening structure that allows installing the display panel inside another display panel that is part of the street furniture, using the illumination of the latter instead of the illumination of the display panel itself.

### OBJECT OF THE INVENTION

The present invention relates to an advertising display panel with image updating and to improvements for said panel that allow installing it in other standard display panels provided in street furniture and having their own illumination means.

### BACKGROUND OF THE INVENTION

Different advertising display panels are known, illuminated or not, which have the drawback of being static; this is, the image or message displayed does not change over time.

Other systems that do allow updating said image are based on either moving prisms or television monitors, but they are expensive and, in the case of prisms, their operation is not entirely satisfactory.

These drawbacks are overcome by the use of the display panel of the invention, which is suitable for installation in diverse sites such as telephone booths, shopping malls, public transport stations or stops, etc.

On another hand, standard advertising display panels are known widely used in street furniture that are provided with a pedestal and an opening upper part with their own internal illumination, wherein the use of vinyl parts or similar plastic parts allow displaying advertisements which in this case consist of a single image.

These urban furniture display panels can also mount the display panel object of the present invention by means of certain adaptations, which also form part of the invention, favouring their implementation and increasing the possibilities of urban display panels by allowing them to show several changing images.

### DESCRIPTION OF THE INVENTION

The display panel of the invention is ideal for showing several images and updating them, with remarkably low costs and a simple operation compared to other systems.

According to the invention, the display panel consists of a casing that encloses one or more lamps meant to illuminate the images displayed.

The casing has an opening with a rigid and fixed transparent portion resembling a flat TV screen, and another mobile and transparent portion inside the casing parallel and opposite to the former portion.

One of these two portions incorporates a pattern or mask of opaque areas, while the other portion incorporates a plurality of fragmented images in agreement with the pattern of opaque areas so that the spaces between the opaque areas of the mask will show, when illuminated from the inside, the fragments of a single image, while the fragments of the other images will be concealed by the opaque areas.

The mobile portion, on the inside, is provided with means to transmit its motion in order to change the relative position of the image fragments and the opaque areas of the mask, thereby changing the image displayed.

Also proposed are improvements of the invention that are optimal for installing the advertising display panel with image updating of the invention inside another standard display panel of those that form part of urban furniture.

The advertising display panel to be installed inside the other standard display panels basically comprises a transparent rigid fixed portion opposite another also transparent but mobile portion, one of the two holding a mask made of opaque areas and the other a set of fragmented translucent images in agreement with the arrangement of the opaque areas, so that only the fragments of one image are shown through the spaces between the opaque areas when they are backlit, changing the image displayed when the mobile portion moves and the fragments of the various images are placed in front.

The improvements are particularly applicable to the specific case in which the mobile portion is implemented by a flexible plastic sheet printed with translucent ink, mounted interchangeably between the transparent rigid fixed portion on which the opaque area pattern is set and another transparent rigid portion that acts as support and to which the movement is transmitted.

The improvements consist of incorporating both rigid portions and the flexible sheet with the images in an opening structure comprising a fixed frame and a swivelling frame hinged to one another, to allow opening it in order to exchange the flexible sheet in a simple and quick manner.

The rigid frame includes means allowing a quick assembly inside the standard urban display panel, which is provided with its own internal illumination.

The fixed rigid transparent portion is mounted on one of the frames of the structure, while the mobile transparent rigid portion is mounted on the other frame. Depending on which one incorporates the mask of opaque areas, the other will bear the printed sheet with the image strips.

The standard display panel that will contain this structure will be provided with a window placed opposite the images displayed.

Therefore, the improvements of the invention allow a simple installation of the structure inside the urban display panel and the use of its internal illumination.

On another hand, it is also possible to change the images displayed simply and quickly by opening the structure proposed by the invention and replacing the printed sheet.

### BRIEF DESCRIPTION OF THE DRAWINGS

FIG. 1 shows an external view of the display panel of the invention.

FIG. 2 shows a section along the line II-II of FIG. 1.

FIG. 3 shows a section along the line II-II of FIG. 1 for an alternative embodiment of the invention.

FIG. 4 shows a section along the line II-II of FIG. 1 in another alternative embodiment of the invention.

FIG. 5 shows a detail of FIG. 2.

FIG. 6 shows a detail of FIG. 3.

FIG. 7 shows a detail of FIG. 4.

FIG. 8 shows a view of an urban display panel including the display panel with variable images according to the improvements of the invention.

FIG. 9 shows a view of the urban display panel of FIG. 8 open before introducing the display panel with the improvements of the invention.

FIG. 10 shows a view of FIG. 9 with the display panel provided with the improvements of the invention already installed in it.

FIG. 11 shows a front view of the display panel incorporating the improvements of the invention.

FIG. 12 shows a side view of the display panel incorporating the improvements of the invention.

FIG. 13 shows a side view of the display panel incorporating the improvements of the invention in an open position for replacing the internal sheet.

### DESCRIPTION OF A PRACTICAL EMBODIMENT OF THE INVENTION

The display panel 1 of the invention comprises a casing 2 with internal lamps 3 meant to illuminate the images displayed.

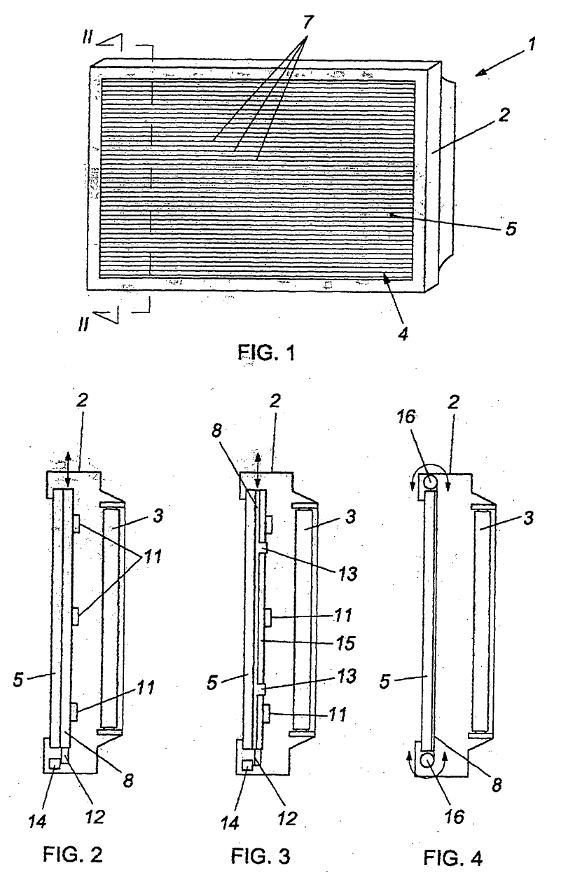

The illumination is transmitted to the outside through an opening 4 of the casing, which is provided with a fixed and transparent front portion 5, ideally a glass pane, which incorporates a mask or pattern of opaque areas 6, in this non-limiting example of the invention, horizontal strips 7. As shown in FIG. 1, the external appearance of the device of the invention resembles a flat-screen television and the images displayed will likewise resemble the images projected or displayed in said type of screens.

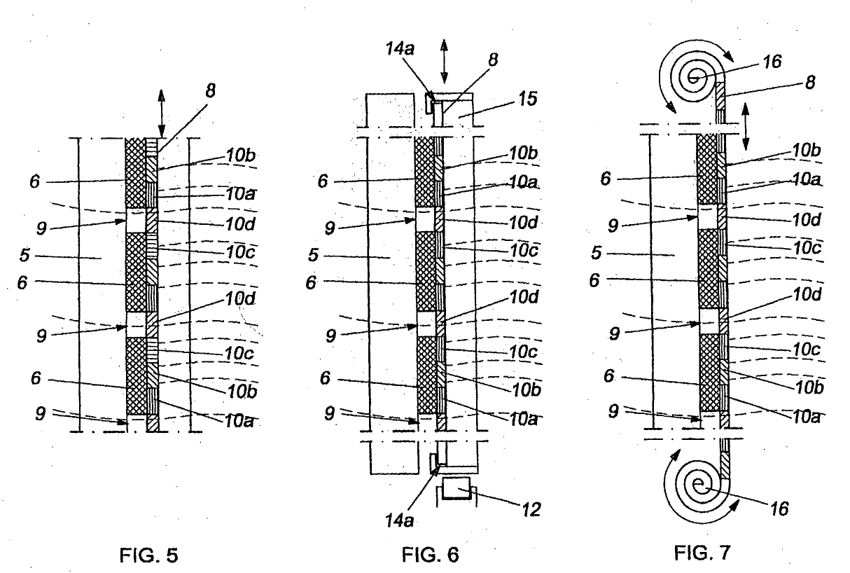

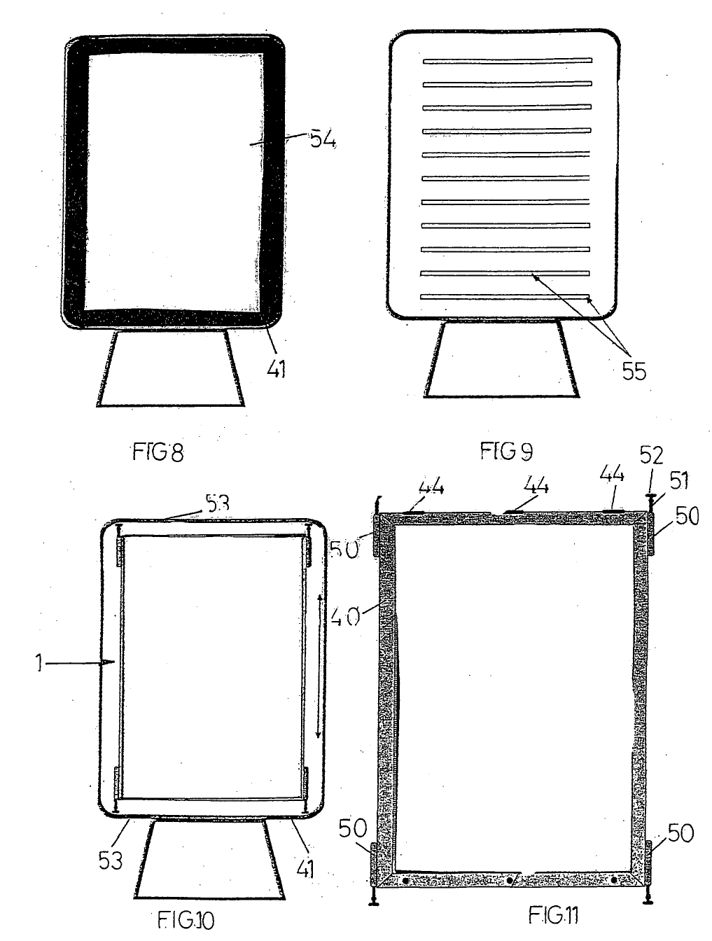

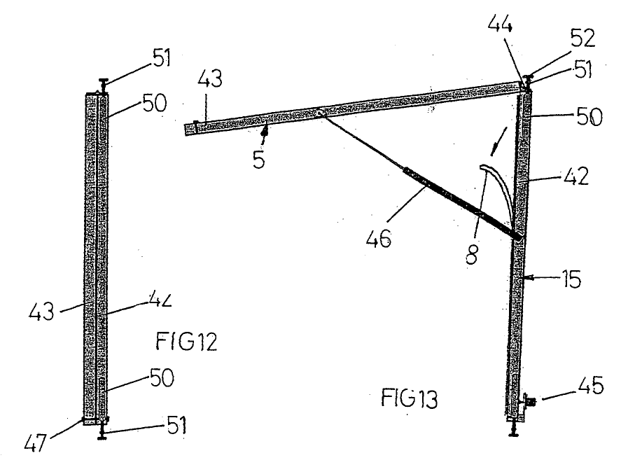

Parallel to portion 5, on the internal part of the casing, is disposed a mobile and transparent portion 8 that incorporates a plurality of fragmented, interposed images in agreement with the pattern of opaque areas of the support 5, so that a suitable adjustment of this mobile portion will reveal through the spaces 9 between the opaque areas 6 of the support 5 only the fragments of a single image. For example, FIGS. 5, 6 and 7 show labelled as 10a, 10b, 10c and 10d the fragments of four images, in which only the fragments 10d of one of the images are aligned with the spaces 9, the remaining ones being covered by the opaque areas 6. The optical effect created by the light that leaves the device will be that of a single image, quite similar to those shown in television screens. Changing the relative position of portion 5 and portion 8 will change the image displayed, as the fragments of another image will be aligned with the spaces 9.

It should be noted that the figures exaggerate the thickness of the opaque areas 6 and the fragments 10a, 10b, 10c and 10d for the sake of clarity; in reality they are extremely thin.

For a correct operation, the width of the horizontal strips must be a whole multiple of the width of the spaces 9, while the width of the image fragments 10a, 10b, 10c and 10d must be identical to the width of the spaces 9. If the width of the strips 7 is the same as the width of the spaces 9, the display panel can show two images. If the width of the strips 7 is twice the width of the spaces 9, the display panel can show three images, and so on.

Inside the casing is implemented an obvious power supply, not shown, which supplies power to the lamps and means for moving the mobile portion 8.

The invention can also be embodied with the opposite approach, incorporating the fragmented images in the external fixed portion and the mask of opaque areas in the inner mobile area, although this embodiment is less convenient.

The mobile portion 8 can be embodied in several ways, according to the invention.

In the first embodiment shown in FIGS. 2 and 5, said mobile portion consists of a rigid and transparent piece, such as made of glass, on which the images are printed directly with translucent ink, provided with lateral bearings 11 and bottom cams 12 driven by a step motor 14 that guide it and provide the motion.

In another alternative embodiment shown in FIGS. 3 and 6, the portion 8 consists of a flexible transparent printed sheet that is supported, in a detachable manner using tabs 13, by the end rails 14a of a transparent piece 15 that support it on one face and implements recesses, not shown, for stabilising its position, while on its opposite face the sheet is held by the fixed portion 5. The movement, as in the previous case, is provided by motorised cams and transmitted to the piece 15 for changing the image. This embodiment has the advantage that it allows changing or updating the images shown in a simple and inexpensive manner by only changing the portion or sheet 8.

In another alternative of the invention shown in FIGS. 4 and 7 the portion 8 consists of a transparent flexible sheet placed between two end rolls 16, providing support to the fixed portion as shown in the figures. The strips 10a, 10b, 10c and 10d are printed on said sheet with translucent ink.

In addition, other elements can be added to the device of the invention such as sound players, not shown, to reinforce the message displayed.

Regarding the printing of the images, digital printing techniques (CMYK) are preferred as they reduce costs, in all cases with translucent ink.

The improvements of the display panel of the invention are applied to the alternative in which the image strips are disposed on an interchangeable sheet, which as shown in FIG. 6 consist of mounting the fixed portion 5 and mobile portion 15 on an opening structure 40, which simplifies on one hand replacing the sheet 8 and on another installing the display panel 1 inside other standard display panels 41 that form part of the urban furniture, which in addition are provided with their own illumination that is used by the display panel 1.

The structure 40 comprises a fixed frame 42 and a swivelling frame 43 connected to each other by the corresponding hinges 44.

The rigid portion 15 and the mechanism 45 that transmits the motion to it (which in this non-limiting example of the invention consists of an electric motor is with a reducer and cams) are mounted on the fixed frame 42. The portion 15 supports the sheet 8. Also mounted on the fixed frame 42, although not shown, are the guides or bearings that participate in the accurate and smooth motion of the portion 15.

The portion 5 bearing the mask of opaque areas is mounted on the frame 43. To prevent the two frames from becoming misaligned due to the weight of the portion 5, the two frames are preferably hinged at the top, in which case a hydraulic arm 46 is implemented which participates in the simple opening of the structure.

In this open position it is extremely simple to replace the sheet 8 with another sheet in order to update the images.

Also implemented are means of sufficient precision to prevent a misalignment of the frames when closing the structure, which could result in distorted images. In this example of embodiment, through screws 47 have been chosen that act as lugs to improve the closure.

Lastly, to attach the structure 40 including the display panel 1 to the urban display panel 41, welded to the fixed frame 42 are threaded bushes 50 for protruding screws 51 with support feet 52 which, by adjusting their separation or extension, will rest on two internal opposing crossbars 53 of the display panel 41 and fix the structure. In addition, the display panel 41 will have a corresponding window 54 for displaying the images, using the light provided by its internal lamps 55 to backlight them.

Having described the nature of the invention and its practical embodiment, it should be noted that the dispositions described above and represented in the accompanying drawings can vary their details provided the essence of the invention is not affected.

1. Advertising panel with image updating and improvements of said panel; the panel comprising a casing with internal lamps, the light of which is transmitted to the outside through an opening in which is disposed a rigid and fixed transparent portion, while a mobile transparent portion is disposed on the inside, parallel and opposite to the former portion, one of the portions incorporating a pattern or mask formed of opaque areas and the other portion incorporating a plurality of fragmented images that follows the pattern of opaque areas to show through the spaces between the opaque areas only the fragments of one of the images, the rest being concealed by the opaque areas themselves; the transparent internal portion is mobile in order to select the image that is shown through the spaces between the opaque areas.

2. Display panel according to claim 1, wherein the pattern of opaque areas is implemented by interspaced opaque parallel strips, while the images are fragmented into strips of a width equivalent to the spaces between the opaque strips; the width of the opaque strips is an integer multiple of the width of the spaces between them, in order to cover one or more images.

3. Display panel according to claim 1, wherein the mobile body consists of a rigid transparent portion, such as a glass pane, moved by the action of connecting rods driven by a step motor, provided with bearings to facilitate its motion.

4. Display panel according to claim 1, wherein the mobile portion consists of a transparent flexible sheet printed using translucent inks that is interchangeably inserted between an internal transparent piece that provides it with support on one of its faces and the external fixed portion that provides the opaque areas mask, which provides it with support on the opposite face, the transparent piece incorporating recesses and rails for stabilising and fixing the position of the sheet, the sheet incorporating tabs or the like to facilitate its extraction while the movement that changes the images shown is transmitted to the transparent piece.

5. Display panel according to claim 1, wherein the mobile portion consists of a transparent flexible means printed using translucent inks that can be wound between two rolls placed on the ends or the sides of the fixed portion.

6. Improvements for an advertising display panel with image updating according to claim 1, for display panels of the type comprising a fixed rigid transparent portion parallel and opposite to another mobile transparent rigid portion, one of them incorporating a mask of opaque areas and being supported by the other, between the two portions being disposed the sheet printed with translucent ink with a plurality of images divided into interposed fragments in agreement with the pattern of opaque areas; wherein they comprise the implementation of an opening structure based on a fixed frame and a swivelling frame hinged to each other, the fixed frame incorporating means for a quick assembly of the structure inside an urban display panel with its own internal illumination; the fixed rigid transparent portion is mounted on one of the frames and the mobile transparent portion is mounted on the other frame together with its means of motion, allowing to exchange the sheet when opening the structure.

7. Improvements according to claim 6, wherein preferably the fixed rigid transparent portion is mounted on the swivelling frame and it incorporates the mask of opaque areas, while the printed sheet is supported on the mobile rigid transparent portion that is mounted on the fixed frame of the structure.

8. Improvements according to claim 6, wherein the swivelling frame is connected to the fixed frame by upper hinges, implementing a hydraulic arm that participates in opening the structure.

9. Improvements according to claim 6, wherein the means for a quick assembly of the fixed frame inside the urban display panel consist of threaded bushes joined to said fixed frame meant to receive protruding screws with supporting legs on opposing crossbars in the inner part of the urban display panel.

10. Improvements according to claim 6, wherein the closure of the structure is implemented by means of suitable precision to avoid misalignment of the two frames of the structure.

11. Improvements according to claim 10, wherein the precision means used in the closure of the structure consist of through screws.
